(19) United States
(12) Patent Application Publication
(10) Pub. No.: US 2026/0367899 A1
(43) Pub. Date: Nov. 19, 2026

(54) LIVE VERIFICATION OF COMPUTE CORE IN STORAGE DEVICES

(71) Applicant: Sandisk Technologies, Inc., Milpitas, CA (US)

(72) Inventor: RAMANATHAN MUTHIAH, Bangalore (IN)

(73) Assignee: Sandisk Technologies, Inc., Milpitas, CA (US)

(21) Appl. No.: 19/207,442

(22) Filed: May 14, 2025

(51) Int. Cl. G06F 8/65; G06F 11/34; G06F 11/3604

(52) U.S. Cl. CPC G06F 8/65; G06F 11/3457; G06F 11/3604

(57) ABSTRACT

A storage device may provide a verification environment to verify a new firmware image that is to be loaded into a compute core to ensure that the new firmware image allows the compute core to meet its functional and performance requirements. A controller on the storage device may include multiple compute cores, each of which may be configured to meet predefined functional and performance requirements. Prior to replacing a current firmware on a compute core, the controller may simulate a storage workload on the storage device and execute functional-and-performance input/output (IO) verification on the new firmware image using a set of input vectors. The controller may determine when the IO verification is successful, commit the new firmware image to the memory, and update the current firmware with the new firmware image to manage functional and performance requirements on the compute core.

### BACKGROUND OF THE INVENTION

A storage device may be communicatively coupled to a host and to non-volatile memory including, for example, a NAND flash memory device on which the storage device may store data received from the host. The storage device may be a compute-storage device that may include one or more compute cores/accelerators, i.e., one or more processors that are provided to perform certain tasks and enhance the processing capacity of the storage device. For example, the compute cores may be used to perform computation within the storage device to ensure efficient data transfer and storage. A controller in the storage device may manage the operations of the storage device and perform storage services for the compute cores/accelerators. The controller may share resources with the compute cores for carrying out conventional storage functions on the storage device and for compute functions carried out by the compute cores. As such, a storage environment with one controller that is provided to manage conventional storage functions of the storage device is different from a compute storage environment with respect to data bandwidth.

A compute core may include software and/or hardware to carry out the functions of the compute core (including, for example, quick computations within the memory device) and to meet the performance requirements of the compute core. When the storage device includes multiple compute cores, each compute core may be associated with firmware, that when executed, may enable the compute core to perform a specific function and meet specific performance requirements. As such, the firmware associated with a compute core may be used to modify and/or manage the functionality and the performance of the compute core. For example, the firmware associated with a compute core could enable the compute core to run at a higher or lower clock speed or use more or less resources.

In a conventional storage device, the controller on the storage device may update the firmware associated with a compute core in a time-sensitive operation that may generally be limited to a very brief period of time. If, for example, the current firmware being executed on the compute core no longer meets the functional and performance requirements of the compute core, a new firmware may be downloaded to replace the current firmware. If the updated firmware also does not meet the functional and performance requirements of the compute core, another firmware may be downloaded, possibly leading to periods where the firmware associated with the compute core may be stale (i.e., unable to meet the functional and performance requirements of the compute core). What is needed is an environment on a system-on-a-chip (SoC) on the storage device where the firmware for a compute core may be tested and verified to meet the functions and performance of the compute core prior to the firmware being updated.

### SUMMARY OF THE INVENTION

In some implementations, a storage device may provide a verification environment to verify a new firmware image that is to be loaded into a compute core to ensure that the new firmware image, once loaded into the compute core, allows the compute core to meet its functional and performance requirements. The storage device may include a memory to store information associated with the compute core. A controller on the storage device may include multiple compute cores, each of which may be configured to meet predefined functional and performance requirements. Prior to replacing a current firmware on a compute core, the controller may simulate a storage workload on the storage device and execute functional-and-performance input/output (IO) verification on the new firmware image using a set of input vectors obtained from the memory. The controller may determine that the IO verification is successful, commit the new firmware image to the memory, and update the current firmware with the new firmware image to manage functional and performance requirements on the compute core.

In some implementations, a storage device may provide a verification environment to verify a new firmware image that is to be loaded into a compute core to ensure that the new firmware image, once loaded into the compute core, allows the compute core to meet its functional and performance requirements. A controller on the storage device may include multiple compute cores, each of which may be configured to meet predefined functional and performance requirements. Prior to replacing a current firmware on a compute core, the controller may simulate a storage workload on the storage device and initiates verification of the new firmware image, by a CMOS Directly Bonded to Array (CBA) in a memory. The CBA may execute functional-and-performance input/output (IO) verification on the new firmware image using a set of input vectors obtained from the memory, determine that the IO verification is successful and commit the new firmware image to the memory. The CBA may also update the current firmware with the new firmware image to manage functional and performance requirements on the compute core.

In some implementations, a method is provided on the storage device for providing a verification environment in a storage device to verify a new firmware image that is to be loaded into a compute core to ensure that the new firmware image, once loaded into the compute core, allows the compute core to meet its functional and performance requirements. The method includes simulating a storage workload on the storage device prior to replacing a current firmware on the compute core and executing functional-and-performance input/output (IO) verification on the new firmware image using a set of input vectors obtained from a memory. The method also includes determining that the IO verification is successful and committing the new firmware image to the memory. The method further includes updating the current firmware with the new firmware image to manage functional and performance requirements on the compute core.

### BRIEF DESCRIPTION OF THE DRAWINGS

FIG. 1 is a schematic block diagram of an example system in accordance with some implementations.

FIG. 2 is a schematic block diagram of an example verification environment on a storage device in accordance with some implementations.

FIG. 3 is another schematic block diagram of an example verification environment on a storage device in accordance with some implementations.

FIG. 4 is an example flow diagram for verifying a new firmware image for a compute core on a storage device in accordance with some implementations.

FIG. 5 is another example flow diagram for verifying a new firmware image for a compute core on a storage device in accordance with some implementations.

FIG. 6 is a diagram of an example environment in which systems and/or methods described herein are implemented.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

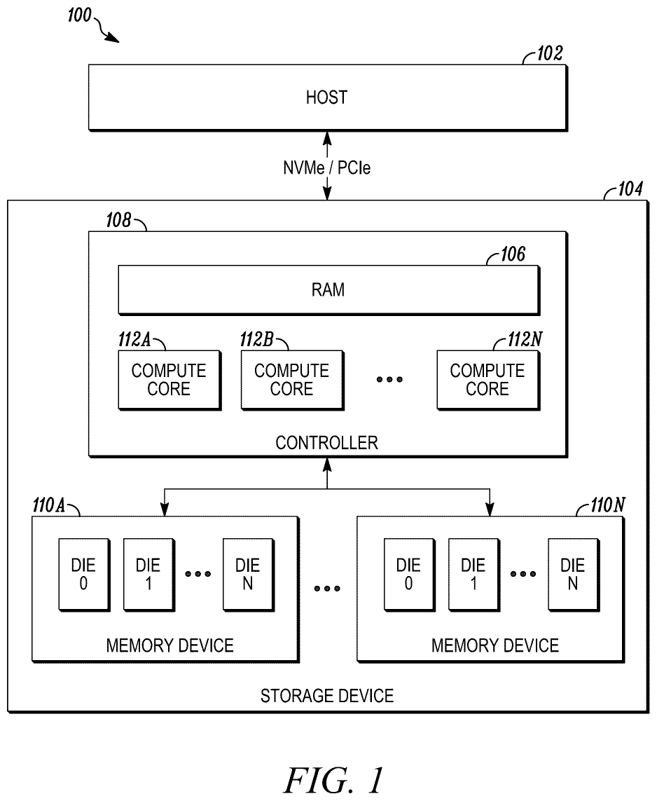

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may be, for example, a solid-state drive (SSD) that may include a random-access memory (RAM) 106, a storage controller 108, one or more storage components such as non-volatile memory devices 110a-110n (referred to herein as the memory device(s) 110), and one or more compute cores/accelerators 112a-112n (referred to herein as compute core(s) 112). RAM 106 may be, for example, static RAM (SRAM) or dynamic RAM (DRAM) that be used to temporarily store data on storage device 104. For example, RAM 106 may store portions of a logical-to-physical (L2P) table that may be used to map a logical block address (LBA) in a host command to a physical address on memory device 110. RAM 106 may also be used to temporarily cache a firmware image associated with a compute core when the firmware for the compute core is being verified.

Storage controller 108 may interface with host 102 and process foreground operations including instructions transmitted from host 102. For example, storage controller 108 may read data from and/or write to memory devices 110 based on instructions received from host 102. Storage controller 108 may also execute background operations to manage resources on memory device 110. For example, storage controller 108 may monitor memory devices 110 and may execute garbage collection and other relocation functions per internal relocation algorithms to refresh, recycle, and/or relocate the data on memory devices 110. In an implementation, storage device 104 may be a compute-storage device 104. As such, storage controller 108 may include one or more compute cores 112 to ensure efficient data transfer and storage.

Memory devices 110 may be flash based. For example, memory devices 110 may be a NAND or NOR flash memory that may be used for storing host and control data over the operational life of memory devices 110. Memory devices 110 may include one or more dies (i.e., DIE 0-DIE N) connected to a memory bus including data lines and chip enable lines. Memory devices 110 may save data in blocks in various formats, with the formats being defined by the number of bits that may be stored per memory cell. Memory device 110 may be included in storage device 104 or may be otherwise communicatively coupled to storage device 104.

Each compute cores 112 may have to meet predefined functionality and performance requirements that may change based on application use cases. The firmware used to execute a compute core 112 may have to be upgraded while storage device 104 is being used to ensure that the compute core 112 meets its predefined functionality and performance requirements. Given that the quality-of-service provided by a compute core 112 is an important criterion, when the firmware used to execute the compute core 112 is being upgraded, the firmware image may be tested/verified prior to being loaded onto the compute core 112. Storage device 104 may therefore provide a verification environment wherein a new firmware image that is to be loaded into a compute core 112 may be verified to ensure that the firmware, once loaded into the compute core 112, allows the compute core 112 to meet its functional and performance requirements.

After downloading/receiving a new firmware image from host 102 for a compute core 112 (for example, compute core 112a which is also referred to herein as a first compute core 112), the storage controller 108 may simulate a verification environment by blocking other compute cores 112 that are not relevant to the new firmware image. Storage controller 108 may delay other storage input/output (IO) functions and/or host requests to set up a verification environment that is free from external factors. Storage controller 108 may execute functional-and-performance IO verification on the new firmware image for first compute core 112 using a set of input vectors. When the IO verification is successful, storage controller 108 may commit the new image for first compute core 112 and a corresponding logical-to-physical (L2P) mapping to a main meta block in memory device 110. The main meta block may be a logical block where a flash translation layer (FTL) may store and manage all the firmware of all compute cores 112. At a later time, the current firmware on first compute core 112 (i.e., the firmware being executed on first compute core) may be updated/replaced with the new/verified firmware image. For example, the current firmware on first compute core 112 may be replaced with the new/verified firmware image when there is a change in functional and/or quality-of-service requirements for first compute core 112, wherein the new firmware image may modify the functionality and/or performance of first compute core 112. FIG. 1 is provided as an example. Other examples may differ from what is described in FIG. 1.

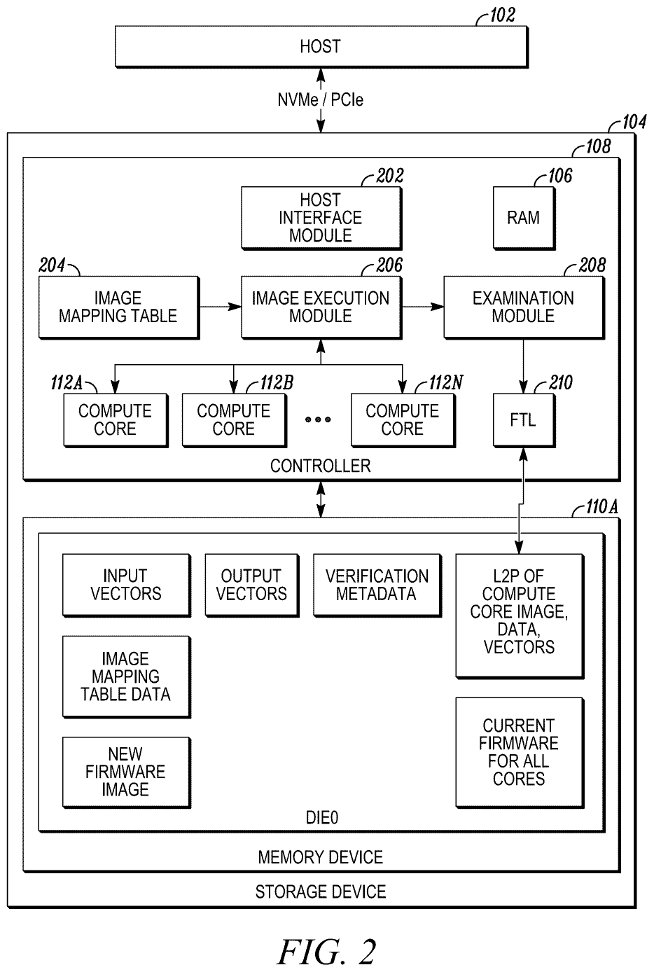

FIG. 2 is a schematic block diagram of an example verification environment on a storage device in accordance with some implementations. The verification environment may include storage controller 108 that may be communicatively coupled to one or more dies on memory device 110, for example, one or more dies on memory device 110a. Storage controller 108 may be a compute core system-on-a-chip (SoC) that may include a host interface module 202, an image mapping table 204, an image execution module 206, an examination module 208, and a flash translation layer (FTL) 210. Storage controller 108 may also include compute cores 112.

Host interface module 202 may be used as an interface between storage controller 108 and host 102. Image mapping table 204 may include identifiers for compute cores 112 and may include a map that may match a compute core identifier with associated input vectors, output vectors, and/or verification meta data. Image execution module 206 may be used to execute firmware images on compute cores 112 using the appropriate input vector for each compute core 112, as provided in image mapping table 204. After image execution module 206 runs a firmware image on a compute core 112, the output vectors from the compute core 112 may be provided to examination module 208 for performance and functional verification. A firmware image that passes the performance and functional verification may be provided to FTL 112 and FTL 112 may commit the firmware image to memory device 110 and update a logical-to-physical mapping for the firmware image.

Memory device 110, for example, memory device 110a, may store input vectors 212, output vectors 214, and verification meta data for compute cores 112. The verification meta data of a compute core 112 may specify acceptable latency for obtaining the output vectors for the compute core 112 when a new firmware image is being executed on the compute core 112. The verification meta data may specify acceptable latency for obtaining the output vectors for the compute core in an environment that is undisturbed by external factors or in an environment where the external factors are managed to an expected level. Memory device 110 may also include new/updated firmware images for compute cores 112, old firmware images for compute cores 112, image mapping table data corresponding to information in image mapping table 204, and L2P mappings for firmware images, data, and IO vectors.

Prior to updating a firmware image on, for example, first compute core 112, a new firmware image for first compute core 112 may be downloaded on storage device 104. Storage controller 108 may load the new firmware image in RAM 106 and block other compute cores 112 that are not associated with the new firmware image from being executed during verification of the new firmware image. Storage controller 108 may also delay other storage IO functions and/or host requests to set up an environment that is free from external factors or to set up an environment where the external factors are managed to an expected level.

During verification, image execution module 206 may identify the input vectors and verification meta data for the new firmware image based on information obtained from image mapping table 204. The verification meta data may include thresholds that image execution module 206 and/or examination module 208 may use in identifying acceptable latency when first compute core 112 generates output vectors. Image execution module 206 may fetch the table entry from image mapping table 204 that corresponds with a compute core identifier associated with first compute core 112 and retrieve the set of verification vectors and the set of IO vectors associated with each of the verification vectors. Image execution module 206 may also fetch the new firmware image for first compute core 112 from RAM 106 and trigger execution of first compute core 112 using the retrieved IO vectors and the new firmware image.

In a compute-storage device 104, storage controller 108 may share the resources for conventional storage as well as compute functionality with compute cores 112. Thus, a storage environment with various storage workloads is an important verification condition for examining the capability of a compute core firmware image. When a compute core 112 is being used, the performance of compute core 112 may depend, not just on its processing capability, but also on the associated IO bandwidth provided by FTL 112. As such, when a new firmware image is being verified, FTL 210 may simulate workloads (by, for example, either increasing or decreasing simulated workloads) with self-generated inputs and outputs when image execution module 206 is executing the new firmware image on first compute core 112. The simulated workload may keep portions of the FTL resources busy and simulate a workload consistent with quality-of-service verification requirements of first compute core 112. The number of simulated workloads used when image execution module 206 is executing the new firmware image on first compute core 112 may be based on a predetermined storage-workload requirement.

After image execution module 206 completes executing the new firmware image on first compute core 112, examination module 208 may verify both the functional and performance capabilities of the new firmware image. For example, in verifying the functional capabilities, examination module 208 may match the real time output from first compute core 112 with standard output vector(s) and, in verifying the performance, examination module 208 may determine if the performance of the new firmware image meets acceptable latency. Examination module 208 may evaluate the success or failure of each of the expected results and based on this evaluation, determine whether to discard or store the new firmware image for first compute core 112 into flash meta blocks meant for core firmware image storage. If examination module 208 determines that the evaluation of the firmware image is successful, examination module 208 may provide an indication to remove the new firmware image from RAM 106, and for FTL 210 to commit the firmware image to the flash meta blocks meant for core firmware image storage and update the L2P table mapping to reflect the storage of the firmware image. If examination module 208 determines that the evaluation of the firmware image is not successful, storage controller 108 may remove the firmware image from RAM 106 and discard the firmware image. Storage controller 108 may provide feedback to external systems on the verification and image acceptance status associated with one or more compute core identifiers.

As noted, updating a firmware image in a compute core is time sensitive. As such, the verification of a new firmware image may occur during a period, for example, of idle time on storage device 104 rather than idle time on compute core 112 The verification of a new firmware image may also occur during a state machine that is not time critical. While the verification is being performed, the current/older firmware image in first compute core 112 may continue to run as needed. When a decision is made to update the firmware image for first compute core 112, the new and successfully tested firmware image may be retrieved from the main meta block using the L2P mapping information and loaded on to first compute core 112.

Storage device 104 may perform these processes based on one or more processors, for example, storage controller 108 and/or memory device 110 (and other components on storage controller 108 and/or memory device 110) executing software instructions stored by a non-transitory computer-readable medium, such as a storage component that may include, for example, memory device 110. As used herein, the term “computer-readable medium” refers to a non-transitory memory device. Software instructions may be read into the storage component from another computer-readable medium or from another device. When executed, software instructions stored in the storage component may cause one or more processors, for example, storage controller 108 and/or memory device 110 (and other components on storage controller 108 and/or memory device 110) to perform one or more processes described herein. Additionally, or alternatively, hardware circuitry may be used in place of or in combination with software instructions to perform one or more processes described herein. For example, the processes described herein may be executed by various components of storage controller 108 and/or memory device 110 (and other components on storage controller 108 and/or memory device 110.), such as processors, logic gates, switches, application specific integrated circuits (ASICs), programmable logic controllers, embedded microcontrollers, and other components of storage controller 108 and/or memory device 110 (and other components on storage controller 108 and/or memory device 110.). Thus, implementations described herein are not limited to any specific combination of hardware circuitry and software. The system used in the verification environment may include additional components (not shown in this figure for the sake of simplicity). FIG. 2 is provided as an example. Other examples may differ from what is described in FIG. 2.

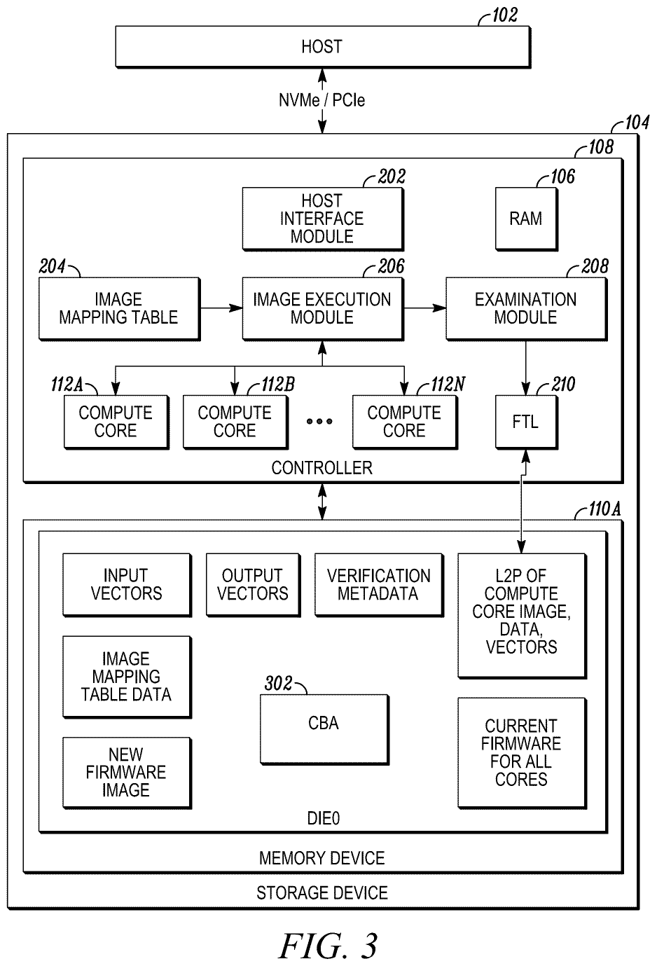

FIG. 3 is another schematic block diagram of an example verification environment on a storage device in accordance with some implementations. The verification environment may include storage controller 108 that is communicatively coupled to one or more dies on memory device 110. Memory device 110, for example, memory device 110a, may include a CMOS Directly Bonded to Array (CBA) 302 wherein storage controller 108 may initiate live verification of a new firmware image of first compute core 112 in the CBA 302 of a memory die. The associated input and output vectors may be present in the same NAND die as CBA 302. The evaluation of the results from the firmware image execution may be triggered in a hardware core present in CBA 302. In some cases, instead of performing the firmware verification for first compute core 112 on one die, the same set of verification actions may be performed in specific groups of CBA dies (not shown) for a specific set of compute cores 112. For example, CBA 302 may be included in dies 0-5 of memory device 110a such that the same set of verification actions may be performed in specific groups of CBA dies (in this case dies 0-5 of memory device 110a) for a specific set of compute cores 112. FIG. 3 is provided as an example. Other examples may differ from what is described in FIG. 3.

Storage controller 108 may therefore perform live and self-verification of new compute-firmware images in the storage environment. The live-verification logic used for verifying a firmware image associated with a compute core may be included in a shipped storage device 104 that may be configured to obtain a firmware image and perform verification according to FTL firmware in a server environment. The components of the verification environment of FIGS. 2 and 3 may thus be used for verification in a live environment wherein a simulated workload may be provided by storage device 104 based on necessity, and the mutually exclusive workloads (for example, resources in storage device 104 that are not associated with the compute core 112 being verified.) Storage device 104 may continue to operate even at a time when the new firmware image of compute core 112 is being upgraded. Thus, a shipped storage device may provide a flexible ability to verify the suitability of a firmware image for one or more of its compute cores 112 based on a set of configurable protocols.

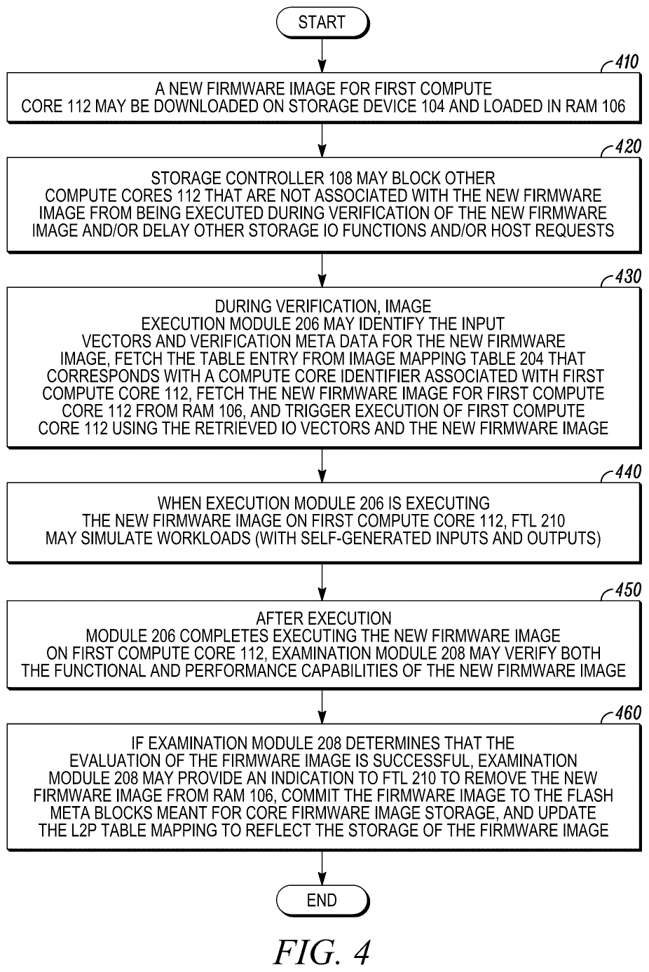

FIG. 4 is an example flow diagram for verifying a new firmware image for a compute core on a storage device in accordance with some implementations. At 410, a new firmware image for first compute core 112 may be downloaded on storage device 104 and loaded in RAM 106. At 420, storage controller 108 may block other compute cores 112 that are not associated with the new firmware image from being executed during verification of the new firmware image and/or delay other storage IO functions and/or host requests. At 430, during verification, image execution module 206 may identify the input vectors and verification meta data for the new firmware image, fetch the table entry from image mapping table 204 that corresponds with a compute core identifier associated with first compute core 112, fetch the new firmware image for first compute core 112 from RAM 106, and trigger execution of first compute core 112 using the retrieved IO vectors and the new firmware image.

At 440, when image execution module 206 is executing the new firmware image on first compute core 112, FTL 210 may simulate workloads (with self-generated inputs and outputs. At 450, after image execution module 206 completes executing the new firmware image on first compute core 112, examination module 208 may verify both the functional and performance capabilities of the new firmware image. At 460, if examination module 208 determines that the evaluation of the firmware image is successful, examination module 208 may provide an indication to FTL 210 to remove the new firmware image from RAM 106, commit the firmware image to the flash meta blocks meant for core firmware image storage, and update the L2P table mapping to reflect the storage of the firmware image. FIG. 4 is provided as an example. Other examples may differ from what is described in FIG. 4.

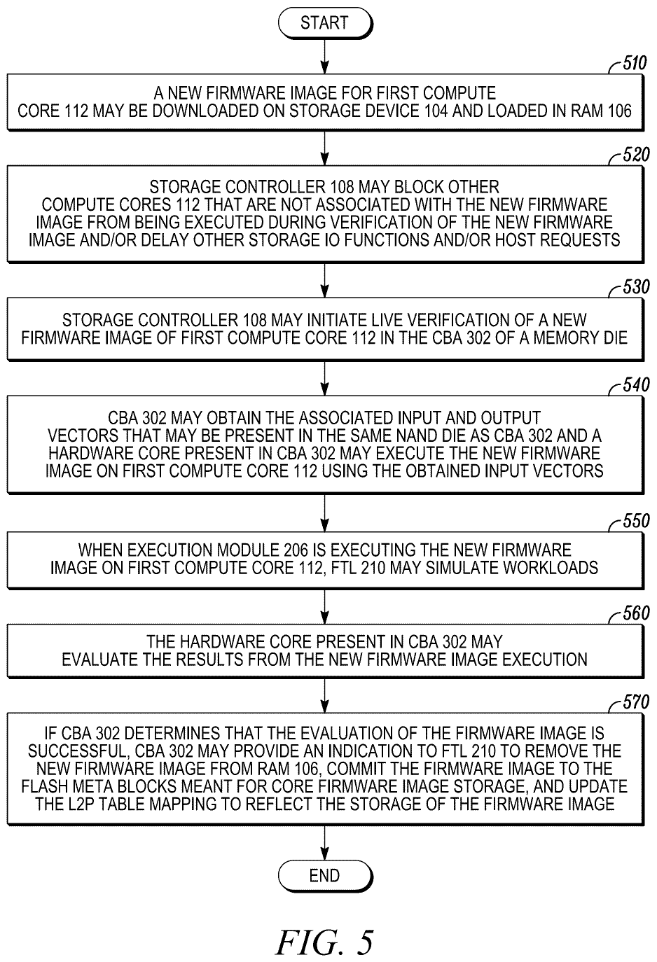

FIG. 5 is another example flow diagram for verifying a new firmware image for a compute core on a storage device in accordance with some implementations. At 510, a new firmware image for first compute core 112 may be downloaded on storage device 104 and loaded in RAM 106. At 520, storage controller 108 may block other compute cores 112 that are not associated with the new firmware image from being executed during verification of the new firmware image and/or delay other storage IO functions and/or host requests. At 530, storage controller 108 may initiate live verification of a new firmware image of first compute core 112 in the CBA 302 of a memory die. At 540, CBA 302 may obtain the associated input and output vectors that may be present in the same NAND die as CBA 302 and a hardware core present in CBA 302 may execute the new firmware image on first compute core 112 using the obtained input vectors. At 550, when image execution module 206 is executing the new firmware image on first compute core 112, FTL 210 may simulate workloads. At 560, the hardware core present in CBA 302 may evaluate the results from the new firmware image execution. At 570, if CBA 302 determines that the evaluation of the firmware image is successful, CBA 302 may provide an indication to FTL 210 to remove the new firmware image from RAM 106, commit the firmware image to the flash meta blocks meant for core firmware image storage, and update the L2P table mapping to reflect the storage of the firmware image. FIG. 5 is provided as an example. Other examples may differ from what is described in FIG. 5.

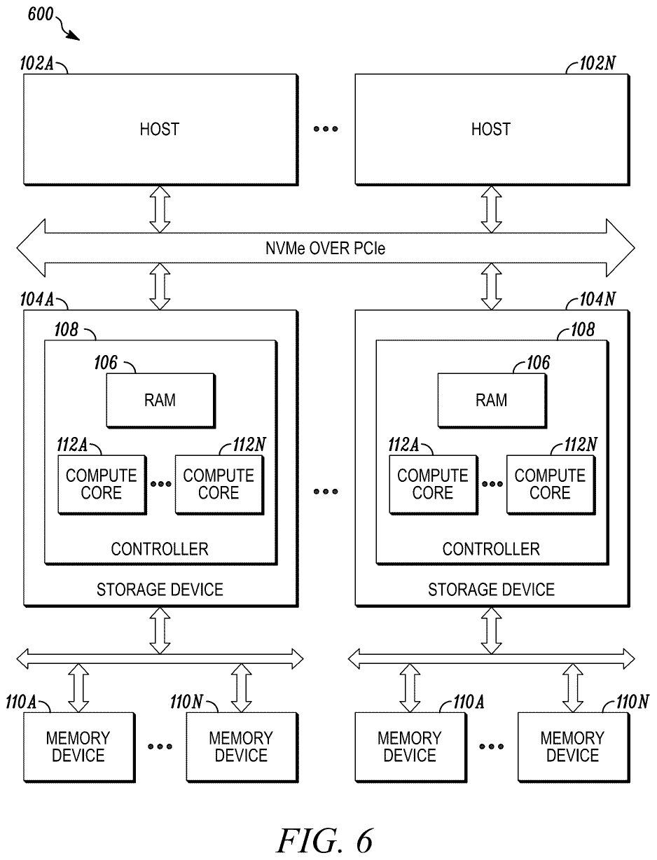

FIG. 6 is a diagram of an example environment in which systems and/or methods described herein are implemented. As shown in FIG. 6, Environment 600 may include hosts 102-102n (referred to herein as host(s) 102), and one or more storage devices 104a-104n (referred to herein as storage device(s) 104). Storage controller 108 may verify a new firmware image for a compute core 112 on a storage device 104 prior to updating the firmware on the compute core 112. Hosts 102 and storage devices 104 may communicate via Non-Volatile Memory Express (NVMe) over peripheral component interconnect express (PCI Express or PCIe), SD, or the like.

Devices of Environment 600 may interconnect via wired connections, wireless connections, or a combination of wired and wireless connections. For example, the network in FIG. 6 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of Environment 600 may perform one or more functions described as being performed by another set of devices of Environment 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to provide a verification environment to verify a new firmware image that is to be loaded into a compute core to ensure that the new firmware image, once loaded into the compute core, allows the compute core to meet its functional and performance requirements, the storage device comprises:
a memory to store information associated with the compute core; and
a controller including a plurality of compute cores to meet predefined functional and performance requirements, wherein prior to replacing a current firmware on the compute core, the controller is to
simulate a storage workload on the storage device and execute functional-and-performance input/output (IO) verification on the new firmware image using a set of input vectors obtained from the memory,
determine that the IO verification is successful and commit the new firmware image to the memory, and
update the current firmware with the new firmware image to manage functional requirements and performance requirements on the compute core.

2. The storage device of claim 1, wherein during the IO verification, the controller at least one of blocks execution of other compute cores and delays at least one of other storage IO functions and host requests to set up an environment where external factors are managed to an expected level.

3. The storage device of claim 1, wherein the memory includes input vectors, output vectors, and verification meta data for compute cores, new firmware images for the compute cores, current firmware images for the compute cores, image mapping table data, and logical-to-physical mappings for firmware images, data, and IO vectors.

4. The storage device of claim 1, wherein the controller is a compute core system-on-a-chip (SoC) that includes a host interface module, an image mapping table, an image execution module, an examination module, and a flash translation layer (FTL).

5. The storage device of claim 4, wherein the image mapping table includes identifiers for the compute cores and includes a map that matches a compute core identifier with at least one of associated input vectors, output vectors, and verification meta data.

6. The storage device of claim 4, wherein the image execution module executes the new firmware image on the compute core using appropriate input vectors and verification meta data for the compute core provided in the image mapping table.

7. The storage device of claim 6, wherein the image execution module uses thresholds included in the verification meta data to identify acceptable latency when the compute core generates output vectors.

8. The storage device of claim 4, wherein the examination module performs performance and functional verification on output vectors for the compute core after the image execution module runs the new firmware image on the compute core.

9. The storage device of claim 4, wherein the FTL i) simulates with self-generated inputs and outputs when the image execution module is executing the new firmware image on the compute core, ii) after the new firmware image passes performance and functional verification, commits the new firmware image to the memory, and updates a logical-to-physical mapping for the new firmware image.

10. A storage device to provide a verification environment to verify a new firmware image that is to be loaded into a compute core to ensure that the new firmware image, once loaded into the compute core, allows the compute core to meet its functional and performance requirements, the storage device comprises:
a controller including a plurality of compute cores to meet predefined functional and performance requirements, wherein prior to replacing a current firmware on the compute core, the controller simulates a storage workload on the storage device and initiates verification of the new firmware image, and
a memory including a CMOS Directly Bonded to Array (CBA) to
execute functional-and-performance input/output (IO) verification on the new firmware image using a set of input vectors obtained from the memory,
determine that the IO verification is successful and commit the new firmware image to the memory, and
update the current firmware with the new firmware image to manage functional requirements and performance requirements on the compute core.

11. The storage device of claim 10, wherein a hardware core in the CBA evaluates results from execution of the new firmware image.

12. The storage device of claim 10, wherein verification of the new firmware for the compute core is performed on one die in the memory.

13. The storage device of claim 10, wherein verification of the new firmware for a specific set of compute cores is performed in a specific group of CBA dies.

14. The storage device of claim 10, wherein during the IO verification, the controller at least one of blocks execution of other compute cores and delays at least one of other storage IO functions and host requests to set up an environment where external factors are managed to an expected level.

15. A method for providing a verification environment in a storage device to verify a new firmware image that is to be loaded into a compute core to ensure that the new firmware image, once loaded into the compute core, allows the compute core to meet its functional and performance requirements, the storage device comprises a controller to execute the method comprising:
simulating a storage workload on the storage device wherein prior to replacing a current firmware on the compute core
executing functional-and-performance input/output (IO) verification on the new firmware image using a set of input vectors obtained from a memory,
determining that the IO verification is successful and committing the new firmware image to the memory, and
updating the current firmware with the new firmware image to manage functional and performance requirements on the compute core.

16. The method of claim 15, further comprising, during the IO verification, at least one of blocking execution of other compute cores and delaying at least one of other storage IO functions and host requests to set up an environment where external factors are managed to an expected level.

17. The method of claim 15, further comprising, during the IO verification, executing the new firmware image on the compute core using appropriate input vectors and verification meta data for the compute core provided in an image mapping table.

18. The method of claim 17, further comprising, during the IO verification, using thresholds included in the verification meta data to identify acceptable latency when the compute core generates output vectors.

19. The method of claim 15, further comprising, during the IO verification, performing performance and functional verification on output vectors for the compute core after the new firmware image is executed on the compute core.

20. The method of claim 15, further comprising, during the IO verification and after the new firmware image passes performance and functional verification, committing the new firmware image to the memory, and updates a logical-to-physical mapping for the new firmware image.
